(19) United States
(12) Patent Application Publication
(10) Pub. No.: US 2009/0148258 A1
(43) Pub. Date: Jun. 11, 2009

(54) PICK AND PLACE APPARATUS INCORPORATING DEBRIS REMOVAL DEVICE

(76) Inventors: Chi Wah CHENG, New Territories (HK); Wang Lung Alan TSE, North Point (HK); Chi Fung Ricky CHAN, New Territories (HK)

Correspondence Address: OSTROLENK FABER GERB & SOFFEN, 1180 AVENUE OF THE AMERICAS, NEW YORK, NY, 100368403, US

(21) Appl. No.: 11/952,259

(22) Filed: Dec. 7, 2007

(51) Int. Cl. B65G 61/00

(52) U.S. Cl. 414/225.01; 414/800

(57) ABSTRACT

A pick and place apparatus is provided for picking up an electronic component from one location and placing it at another location, which comprises a pick up tool having an opening at which electronic components are configured to be held by vacuum suction. An air channel extends through the pick up tool from the opening and is connectable for fluid communication with an air supply source which is operative to blow a quantity of air out from the opening towards the electronic component for removing any debris located thereon. The air channel is also connectable for fluid communication with a vacuum suction source which is operative to generate vacuum suction force at the opening for picking up the electronic component by vacuum suction.

### FIELD OF THE INVENTION

The present invention relates to an apparatus for handling electronic components such as semiconductor packages, and in particular, to the pick-up and offloading of the electronic components.

### BACKGROUND AND PRIOR ART

The singulation of electronic components into individual packages on a mounting tape is one of the key back-end processes for the manufacture of electronic packages such as Chip-Scale Ball Grid Array (“CSBGA”) packages, Quad Flat No leads (“QFN”) packages, and other Chip-Scale Packages (“CSP”). The singulated packages are picked by a pick and place tool and sorted according to test or inspection results. Typically, good packages are then offloaded to a storage container, such as a tray or tube container, or a tape and reel, and rejected packages may be disposed of in a reject bin.

There are two common methods for picking up singulated packages which are mounted on a tape. In one method, a block of singulated packages is optically aligned as a whole using a camera and a pattern recognition (PR) alignment technique adopted to recognize the packages located at the corners. After positional compensation of the block of singulated packages to align them in the correct orientation, each package is picked up individually until all the packages mounted on the tape are removed.

In another method for picking up singulated packages, a block of singulated packages on a mounting tape is optically aligned in the same manner as the first method. Subsequently, each singulated package is optically aligned individually with respect to a pick up tool. The surface of each individual package is also inspected at the same time for the presence of foreign material, such as debris and dislodged tie bars. If any foreign material is found on the surface of a package, the package will not be picked up.

U.S. Pat. No. 7,190,446 entitled “System for Processing Electronic Devices” illustrates the implementation of the second method for picking up singulated packages discussed above. This patent additionally applies an ejection mechanism using an ejector pin to push and lift a singulated package upwards away from the adhesive surface of a mounting tape on which it is mounted so as to separate the package from the tape. While other packages maintain their positions on the tape, a pick up tool comprising a pick head with a vacuum pad is lowered onto the package that has been lifted up to pick it up by vacuum suction. After the package is picked up, the ejector pin returns to its original position. The pick up apparatus may constitute two pick heads to speed up the pick and place process. When one pick head moves to pick up a package, the other one moves to place a package that has been picked up and vice versa. The next package is then indexed to the pick-up position to allow picking up of the package from the tape. This pick-up process is repeated until all the singulated packages have been removed.

More specifically, FIGS. 1A to 1F illustrate side views of a pick up sequence of a conventional pick and place apparatus 100. In FIG. 1A, the PR alignment camera 22 recognizes and verifies whether the position of a first package 16 to be picked up is within a predetermined tolerance. If the alignment of the first package 16 is acceptable, the pick up tool 12 moves to a standby position above the package 16 as shown in FIG. 1B. If the alignment of the first package 16 is incorrect, the X-Y table holding the package 16 carries out positional compensation such that the pick up tool 12 may pick up the first package 16 precisely.

In FIG. 1C, the pick up tool 12 moves downwards to contact the first package 16. An ejector pin (not shown) moves upwards on the other side of the mounting tape 23 to delaminate the first package 16 from the tape. After sufficient vacuum build-up, the pick up tool 12 moves upwards holding the first package 16 as shown in FIG. 1D.

The pick up tool 12 carries the first package 16 for offloading as shown in FIG. 1E. The array of packages 16 is indexed to the next position to allow a second package 16 to be picked up. The PR alignment camera 22 recognizes and confirms the position of the second package 16. The pick up tool 12 moves to the stand-by position as shown in FIG. 1F ready for picking up the second package 16. The pick and place cycle from FIGS. 1A to 1E is repeated until all the packages 16 are removed from the tape.

FIGS. 2A to 2F illustrate side views of another pick up sequence of the conventional pick and place apparatus 100 when foreign material, such as a tie bar 20, is detected on a singulated package 16. In FIG. 2A, the PR alignment camera 22 recognizes and confirms whether the position of a first package 16 is within a predetermined tolerance and checks for the presence of any tie bar 20 on the first package 16. If a tie bar 20 is found on the first package 16, the first package 16 will not be picked up and the array of packages 16 is indexed such that a second package 16 is positioned directly below the PR alignment camera 22 as shown in FIG. 2B.

In FIG. 2C, PR alignment and inspection are conducted on the second package 16. After the position of the second package 16 is confirmed and if no tie bar 20 is found on this package 16, the pick up tool 12 moves to a stand by position above the second package 16, as shown in FIG. 2D. The pick up tool 12 then moves downwards to pick up the second package 16 as shown in FIG. 2E. The pick up tool 12 picks up the second package 16 when there is sufficient vacuum suction built up (FIG. 2F). The pick up tool 12 transports the second package 16 for offloading. The processes from FIG. 2A to 2F are repeated until all the packages 16 that have no foreign material found on them during inspection of the surfaces of the packages 16 have been removed.

However, the above approach has a shortcoming in that, although the singulated packages that are contaminated with foreign materials detected during the PR alignment and inspection are not picked up, a package that has been inspected and verified to be free from foreign material may subsequently be contaminated in the period between the steps of PR alignment and inspection, and actual package pick-up. The pick up tool will still attempt to pick up such contaminated packages. This problem is particularly common when singulated packages with tie bars are being processed. As a result, such contaminated packages may not be picked up and may remain on the tape since the presence of foreign material may reduce the vacuum suction build-up of the pick up tool. Even in the event that the contaminated package is able to be picked up by reduced vacuum suction, the weak holding force of the pick up tool is such that the package may be dislodged when the pick up tool moves away at high speed. This may give rise to missing packages during offloading. It is therefore desirable to ensure that singulated packages are not contaminated with foreign material after PR alignment and inspection, and before these packages are picked up.

### SUMMARY OF THE INVENTION

It is thus an object of the invention to seek to provide a reliable and efficient pick and place apparatus for picking up singulated electronic components which includes a debris removal device to ensure that packages are free from foreign material when they are picked up.

According to a first aspect of the invention, there is provided a pick and place apparatus for picking up an electronic component from one location and placing it at another location, comprising: a pick up tool having an opening at which electronic components are configured to be held by vacuum suction; an air channel extending through the pick up tool from the opening; an air supply source that is connectable for fluid communication with the air channel and which is operative to blow a quantity of air out from the opening towards the electronic component for removing any debris located thereon; and a vacuum suction source that is connectable for fluid communication with the air channel and which is operative to generate vacuum suction force at the opening for picking up the electronic component by vacuum suction.

According to a second aspect of the invention, there is provided a method of picking up an electronic component from one location and placing it at another location, comprising the steps of: positioning an opening of a pick up tool which is connected to an air channel extending through the pick up tool over the electronic component to be picked; connecting an air supply source for fluid communication with the air channel to blow air out of the opening towards the electronic component to remove any debris located thereon; and thereafter connecting a vacuum suction source for fluid communication with the air channel and picking up the electronic component at the opening via vacuum suction for moving it to another location.

It will be convenient to hereinafter describe the invention in greater detail by reference to the accompanying drawings. The particularity of the drawings and the related description is not to be understood as superseding the generality of the broad identification of the invention as defined by the claims.

### BRIEF DESCRIPTION OF THE DRAWINGS

The present invention will be readily appreciated by reference to the detailed description of the preferred embodiment of the invention when considered with the accompanying drawings, in which:

FIGS. 1A to 1F illustrate side views of a pick up sequence of a conventional pick and place apparatus;

FIGS. 2A to 2F illustrate side views of another pick up sequence of the conventional pick and place apparatus when foreign material, such as a tie bar, is detected on a singulated package;

FIG. 3 is an isometric view of a pick and place apparatus comprising a pick up tool incorporating an air blower according to the preferred embodiment of the invention;

FIG. 4 is an enlarged isometric view of the pick up tool of the pick and place apparatus of FIG. 3;

FIG. 5 is a sectional side view of the pick up tool of the pick and place apparatus of FIG. 3;

FIGS. 6A to 6F illustrate side views of a pick up sequence of the pick and place apparatus of FIG. 5 comprising the pick up tool which incorporates an air blower according to the preferred embodiment of the invention; and

FIG. 7 is a flow chart of the pick up sequence which may be performed by the pick and place apparatus of FIG. 5.

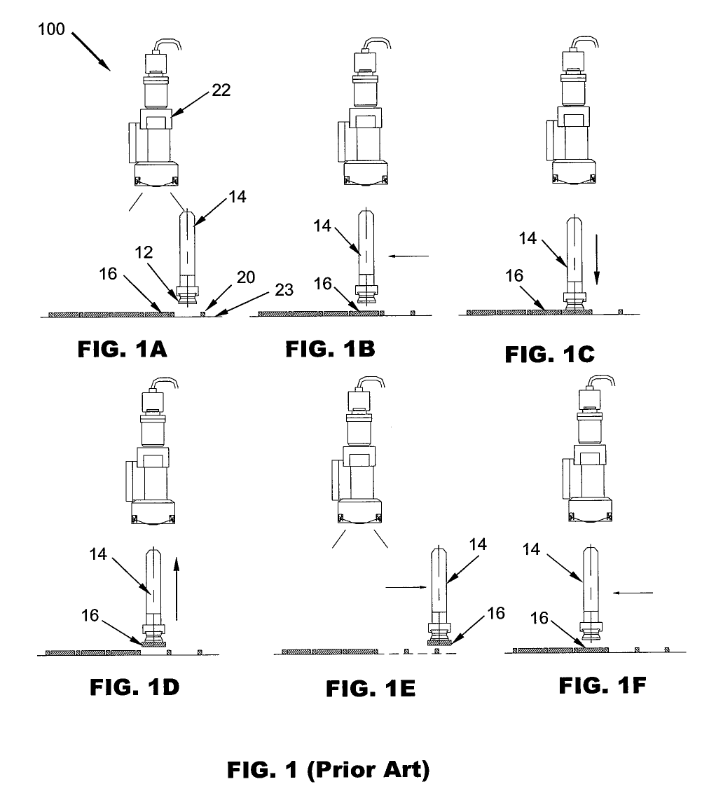

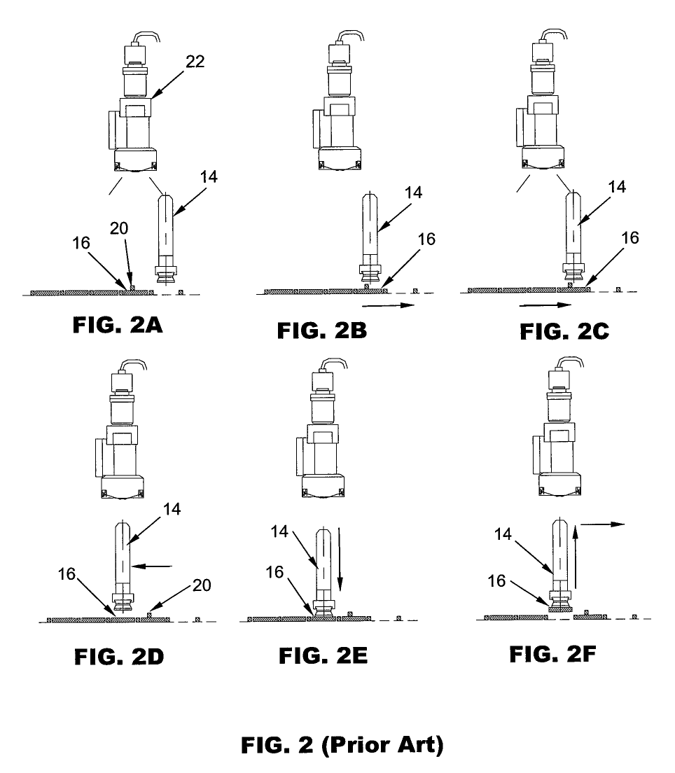

### DETAILED DESCRIPTION OF THE PREFERRED EMBODIMENT OF THE INVENTION

The preferred embodiment of the present invention will be described hereinafter with reference to the accompanying drawings.

FIG. 3 is an isometric view of a pick and place apparatus 10 comprising a pick up tool 12 incorporating an air blower according to the preferred embodiment of the invention. The pick up tool 12 is operative to pick up electronic components, such as electronic packages 16 that have been singulated, from one location and to place them at another location. The pick up tool 12 is supported by a pick arm 14 which is movable in the x-y-θ directions over arrays of singulated packages 16 adhering onto an adhesive tape. The adhesive tape is supported on a wafer ring which is in turn mounted on an X-Y table.

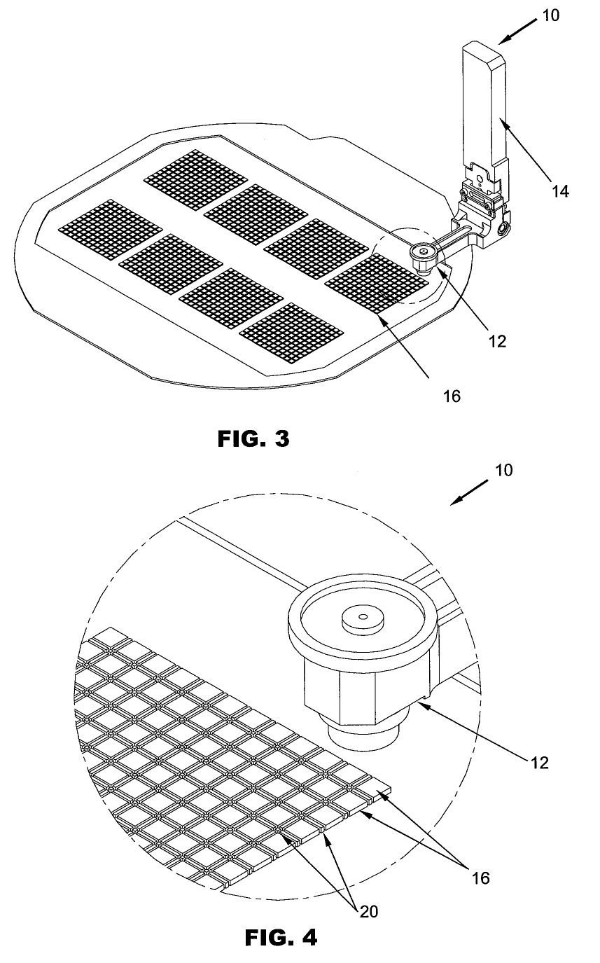

FIG. 4 is an enlarged isometric view of the pick up tool 12 of the pick and place apparatus 10 of FIG. 3. The pick up tool 12 is positioned over a block of singulated packages 16. Tie bars 20 are located in between separate rows of singulated packages 16. These tie bars 20 or other debris may inadvertently land onto the surfaces of the packages 16, giving rise to problems in picking up the packages 16.

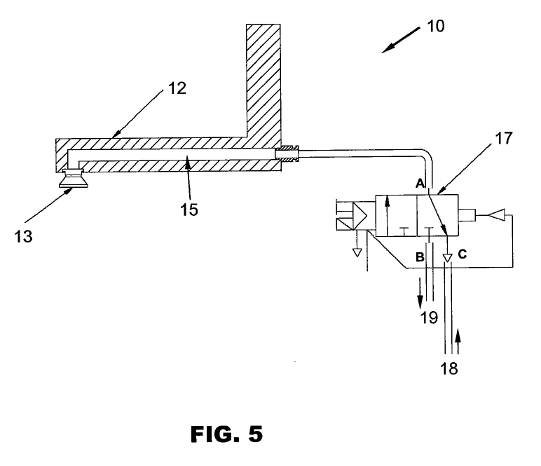

FIG. 5 is a sectional side view of the pick up tool 12 of the pick and place apparatus 10 of FIG. 3. The pick up tool 12 preferably has dual functions which enable it to provide vacuum suction or to serve as an air blower depending on the mode in which it is activated. These dual functions may be implemented using a valve, preferably a pneumatic valve 17. The pneumatic valve 17 is located between and connected to the air channel 15, an air supply source such as a compressed air generator 18, and a vacuum suction source 19.

After PR alignment and inspection of a singulated package 16, the air blower mode is activated. An opening of the pick up tool 12 where a collet 13 is located for holding packages 16 by vacuum suction is positioned in close proximity over a package 16 to be picked up. An air channel 15 extends from the opening through the pick up tool 12. Compressed air is provided from the compressed air generator 18 which is connectable for fluid communication with the air channel 15. The pneumatic valve 17 is set to a first position at opening C, which connects to opening A of the air channel 15 of the pick up tool 12. The compressed air passes from the air channel 15 to the mouth of the collet 13 located at the opening of the pick up tool 12 to blow a quantity of air out from the opening towards the package 16 to remove debris such as any tie bars 20 or other foreign material that may have landed onto the package 16. The direction in which the quantity of air is blown towards the package 16 is substantially perpendicular to the pick-up surface of the package 16 by which the package 16 is held by the vacuum collet 13.

After a programmable delay, the pick up tool 12 switches mode such that the pneumatic valve 17 switches to a second position at opening B so that the vacuum suction source 19 is thereby connected for fluid communication with opening A of the air channel 15 to generate vacuum suction force at the opening to pick up the package 16 with the vacuum collet 13 located at the opening.

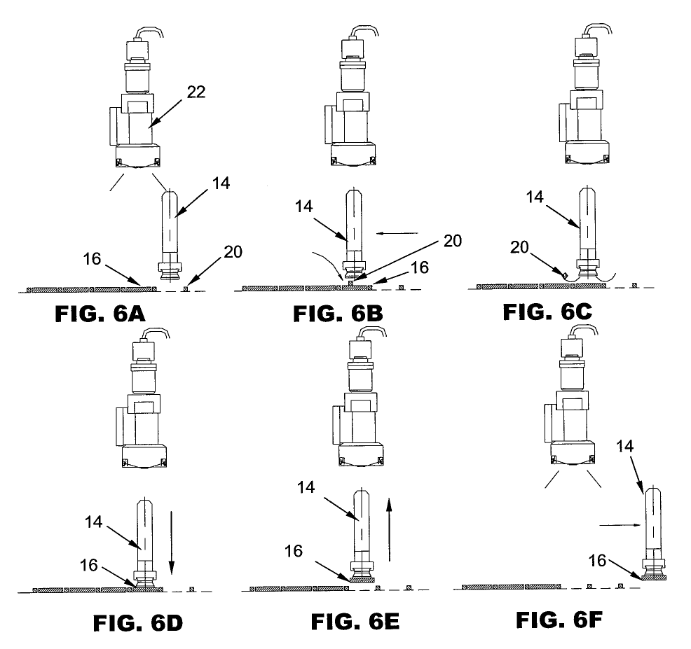

FIGS. 6A to 6F illustrate side views of a pick up sequence of the pick and place apparatus 10 of FIG. 5 comprising the pick up tool 12 which incorporates the air blower according to the preferred embodiment of the invention. In FIG. 6A, a first package 16 is subjected to PR alignment and inspection as well as checks for any tie bars 20 or other foreign material by the PR alignment camera 22. When the first package 16 is aligned within a predetermined tolerance and is verified to be free of any tie bar 20 or other foreign material during inspection by the camera 22, the pick up tool 12 is positioned above this package 16 to pick up the package 16, as shown in FIG. 6B. Meanwhile, a tie bar 20 or other foreign material may land onto the first package 16 before the package 16 is actually picked up. In FIG. 6C, the air blower of the pick up tool 12 is activated as the pick up tool 12 moves downwards towards the first package 16. A stream of air is emitted through the air channel 15 at close proximity to the package 16 to blow the tie bar 20 or other foreign material off the first package 16. The air blower is deactivated after a programmable period, before the vacuum suctioning mode is switched on while the pick-up tool 12 contacts the package 16 as shown in FIG. 6D.

After sufficient vacuum suction build-up, an ejector pin (not shown) pushes upwards against the tape to separate the package 16 from the tape to assist picking up of the package 16 while the pick up tool 12 moves upwards holding the first package 16, as shown in FIG. 6E. In FIG. 6F, the pick up tool 12 transports the first package 16 for offloading. The array of packages 16 is indexed to the next position for a second package 16 to be picked up. The cycle is repeated until all the packages 16 have been removed from the tape.

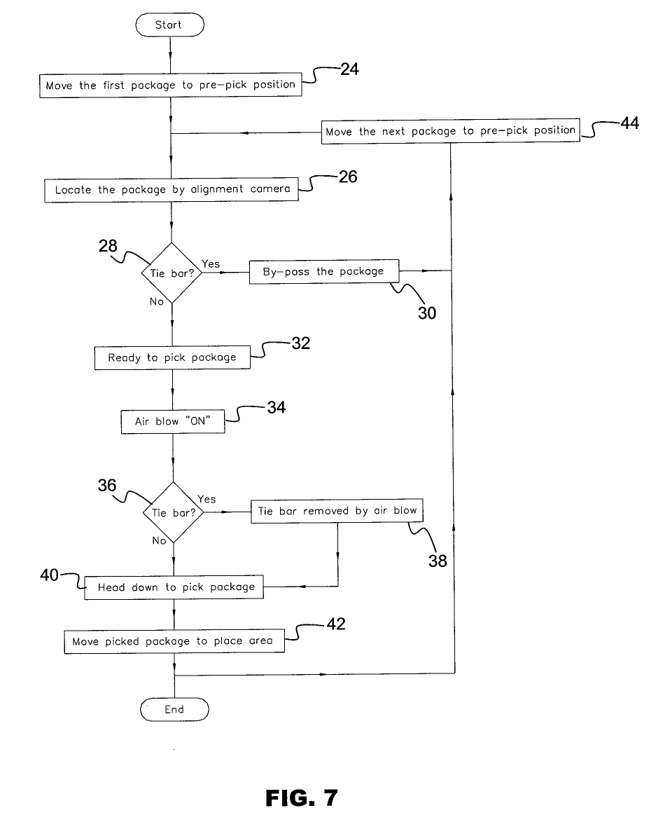

FIG. 7 is a flow chart of the pick up sequence which may be performed by the pick and place apparatus 10 of FIG. 5. First, a package is moved to a pick-up position 24. Optical alignment of the package is carried out 26. The package is inspected for the presence of tie bars 20 or other foreign material 28. When a tie bar 20 is spotted on the package, this package is by-passed 30 and will not be picked up. Another package will then be indexed to the pick-up position 44.

If there are no tie bars or other foreign material on the package, the package is ready to be picked up 32. Before actual pick-up, a stream of compressed air is blown onto the package 34. If there is any tie bar 20 which landed on the package 36, it will be blown off 38. Thereafter, the pick up tool 12 moves downwards to pick up the package 40 and transports it to a placement area for offloading 42. The next package is then indexed to the pick-up position to be picked up 44.

It should be appreciated that the preferred embodiment of the invention described above provides a device for ensuring that a singulated package to be picked up is free from debris such as foreign material before it is actually picked up by a pick up tool. Ultimately, a more reliable apparatus for picking up and placing singulated packages is provided as the risk of encountering missing packages 16 in the placement area is reduced by ensuring that there are no foreign materials on the packages 16. Interruption of the pick up process is also minimized as a result of the reduced incidence of missing packages. Accordingly, the efficiency of the pick-up process increases.

The invention described herein is susceptible to variations, modifications and/or additions other than those specifically described and it is to be understood that the invention includes all such variations, modifications and/or additions which fall within the spirit and scope of the above description.

1. A pick and place apparatus for picking up an electronic component from one location and placing it at another location, comprising:
a pick up tool having an opening at which electronic components are configured to be held by vacuum suction;
an air channel extending through the pick up tool from the opening;
an air supply source that is connectable for fluid communication with the air channel and which is operative to blow a quantity of air out from the opening towards the electronic component for removing any debris located thereon; and
a vacuum suction source that is connectable for fluid communication with the air channel and which is operative to generate vacuum suction force at the opening for picking up the electronic component by vacuum suction.

2. The pick and place apparatus as claimed in claim 1, further comprising a valve located between and connecting the air channel and the vacuum suction and air supply sources, which is switchable between a first position to connect the air supply source and the air channel, and a second position to connect the vacuum suction source to the air channel.

3. The pick and place apparatus as claimed in claim 2, wherein the valve comprises a pneumatic valve.

4. The pick and place apparatus as claimed in claim 1, wherein the air supply source comprises a compressed air generator.

5. The pick and place apparatus as claimed in claim 1, including a vacuum collet located at the opening which is configured to hold the electronic component by vacuum suction.

6. The pick and place apparatus as claimed in claim 1, wherein a direction in which said quantity of air is blown towards the electronic component is substantially perpendicular to a pick-up surface of the electronic component.

7. Method of picking up an electronic component from one location and placing it at another location, comprising the steps of:
positioning an opening of a pick up tool which is connected to an air channel extending through the pick up tool over the electronic component to be picked;
connecting an air supply source for fluid communication with the air channel to blow air out of the opening towards the electronic component to remove any debris located thereon; and thereafter
connecting a vacuum suction source for fluid communication with the air channel and picking up the electronic component at the opening via vacuum suction for moving it to another location.

8. The method as claimed in claim 7, further comprising the step of inspecting the electronic component before positioning the pick up tool over the electronic component, and not picking up the electronic component if debris is found on the electronic component during said inspection.

9. The method as claimed in claim 7, further comprising the step of moving the pick up tool into close proximity with the electronic component prior to blowing air towards the electronic component to remove any debris.

10. The method as claimed in claim 7, further comprising a valve located between and connecting the air channel and the vacuum suction and air supply sources, wherein the step of connecting the air supply source to the air channel further comprises the step of switching the valve to a first position, and the step of connecting the vacuum suction source to the air channel further comprises the step of switching the valve to a second position.

11. The method as claimed in claim 10, wherein the valve comprises a pneumatic valve.

12. The method as claimed in claim 7, wherein the air supply source comprises a compressed air generator.

13. The method as claimed in claim 7, wherein the step of picking up the electronic component by vacuum suction comprises the step of holding it with a vacuum collet located at the opening.

14. The method as claimed in claim 7, wherein a direction in which said quantity of air is blown towards the electronic component is substantially perpendicular to a pick-up surface of the electronic component.
